(19) United States
(12) Patent Application Publication
(10) Pub. No.: US 2012/0039248 A1
(43) Pub. Date: Feb. 16, 2012

(54) METHOD AND SYSTEM FOR IN-VEHICLE WIRELESS CONNECTIVITY

(75) Inventors: Mark Schneider, Northville, MI (US); Jennifer L. Brace, Northville, MI (US); Paul Aldighieri, Grosse Pointe Farms, MI (US); Michael Raymond Westra, Plymouth, MI (US); Sukhwinder Wadhwa, Windsor (CA); Arthur Van Jack, JR., Southfield, MI (US)

(73) Assignee: FORD GLOBAL TECHNOLOGIES, LLC, Dearborn, MI (US)

(21) Appl. No.: 12/854,010

(22) Filed: Aug. 10, 2010

(51) Int. Cl. H04W 40/00

(52) U.S. Cl. 370/328

(57) ABSTRACT

One embodiment of the present invention is a vehicle computer system for establishing in-vehicle wireless connectivity to remote computer network, e.g., the Internet. The system may include a processor in communication with a human machine interface (HMI) for control by a user. The processor may also be in communication with one or more wireless transceivers for wireless data communication. The processor may be capable of being paired to a pneumatic commuting device (e.g., cellphone, PDA, etc.) having wireless Internet connectivity. The processor may be configured to wirelessly connect to one or more personal computing devices in the vicinity of the vehicle, and provide a wireless Internet access point to the one or more personal computing devices based on the wireless connection and the Internet connectivity.

### BACKGROUND

1. Technical Field

Various embodiments relate to wireless connectivity within a vehicle. In some embodiments, a vehicle computer may serve as an in-vehicle wireless access point for one or more devices in a vehicle.

2. Background Art

Some smartphones with WiFi capabilities, such as a BLACKBERRY or IPHONE, have capabilities such that the device can become a wireless Internet access point. However, the mobile device owner is generally required to have a data plan. Further, the device may be limited to offering WiFi access to only one user at a time.

One solution to the problem of single use WiFi hotspots was recently introduced by NOVATEL with the MIFI device. This device, called an “intelligent mobile hotspot,” also requires a data plan through a cellular carrier, but offers up to five connections on one MIFI device. The device combines the functions of a modem, router, and access point such that the modem accesses a wireless signal and the router shares that connection with the multiple devices connected to it. However, like the mobile device hotspots, the MIFI device is cost prohibitive in that the user is required to have a data plan and additionally pay for use of the device. Further, if the user wants to use it in a vehicle, the MIFI device is required, and therefore, an additional device for the user to carry in addition to his or her cellular telephone.

### SUMMARY

One embodiment of the present invention is a vehicle computer system for establishing in-vehicle wireless connectivity to remote computer network, e.g., the Internet. The system may include a processor in communication with a human machine interface (HMI) for control by a user. The processor may also be in communication with one or more wireless transceivers for wireless data communication. The processor may be capable of being paired to a pneumatic commuting device (e.g., cellphone, PDA, etc.) having wireless Internet connectivity. The processor may be configured to wirelessly connect to one or more personal computing devices in the vicinity of the vehicle, and provide a wireless Internet access point to the one or more personal computing devices based on the wireless connection and the Internet connectivity.

In a different embodiment, the vehicle computer system may be configured to receive vehicle transmission position information indicating whether the vehicle is in park, and receive geographic coordinates from a GPS device indicating the geographic location of the vehicle. Upon receiving this information, the process may be configured to query a database to identify one or more known hotspots in the vicinity of the vehicle, and attempt to connect to the one or more known hotspots in order to provide the wireless Internet access point having Internet connectivity.

Another embodiment of the present invention comprises a method for in-vehicle wireless connectivity. The method includes receiving input defining two or more modes for wireless connectivity. The two or more modes may include a client mode for connecting to a connection point outside of a vehicle and an in-vehicle access point mode for generating an in-vehicle connection point. If the vehicle computer is in client mode, the method includes searching for a connection to one or more connection points outside the vehicle and establishing the connection when a connection is found. If the vehicle computer is in in-vehicle access point mode, the method includes tethering a pneumatic device configured to establish an Internet connection to the vehicle computer, and providing a wireless Internet access point for one or more personal computing devices based on the wireless connection and the Internet connection. The computing system may operate in a client mode and in access point simultaneously. Additionally, establishing the connection may include receiving filtering data for determining if the one or more connection points has been visited, filtering the connection point based on the filtering data, and presenting the connection points based on the filtering.

These and other aspects will be better understood in view of the attached drawings and following detailed description of the invention.

### BRIEF DESCRIPTION OF THE DRAWINGS

The figures identified below are illustrative of some embodiments of the invention. The figures are not intended to be limiting of the invention recited in the appended claims. The embodiments, both as to their organization and manner of operation, together with further object and advantages thereof, may best be understood with reference to the following description, taken in connection with the accompanying drawings, in which:

FIG. 1 is an exemplary block topology for a vehicle computing system;

FIG. 2 is an illustrative architecture for enabling WiFi connectivity in a vehicle;

FIG. 3 is an illustrative process for enabling WiFi connectivity in a vehicle according to one embodiment;

FIG. 4 is an illustrative process for operating a WiFi connectivity in a vehicle according to another embodiment.

### DETAILED DESCRIPTION

Detailed embodiments of the invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

WiFi capability within vehicles has been prevalent for a few years. For example, CHRYSLER optionally offers to its customers WiFi capability in a vehicle by installing a physical WiFi hotspot device in the vehicle. For example, the device may be placed underneath a car seat. However, like current personal WiFi network offerings, the service is an added cost to the user and requires extra hardware to enable WiFi connectivity. This is not only cost-prohibitive for user, but may be inconvenient for a vehicle owner. Rather, current technology offered in vehicles and personal devices, such as mobile phones, can be leveraged to offer WiFi connectivity to user without incurring incremental costs or being inconvenient to the user, as described in greater detail herein.

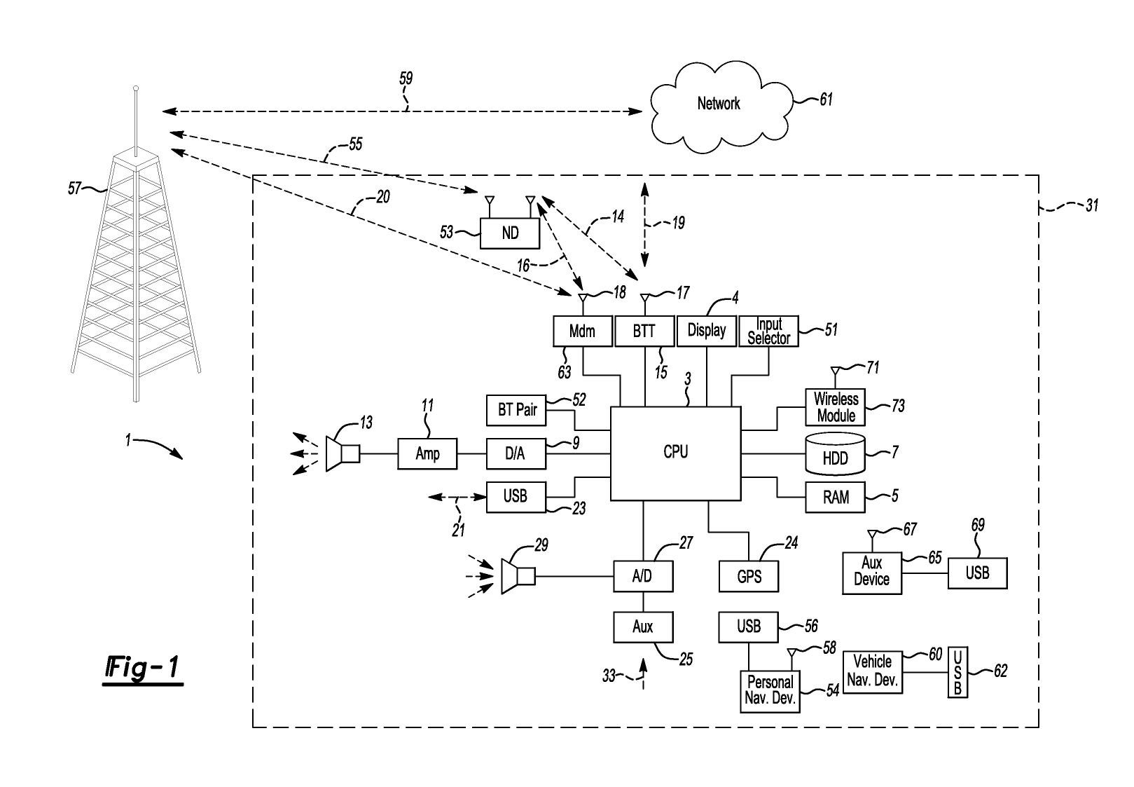

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor.

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device).

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example).

If the user has a data-plan associated with the nomadic device, it is possible that the data-plan allows for broadband transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60, having a USB 62 or other connection, an onboard GPS device 24, or remote navigation system (not shown) having connectivity to network 61.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

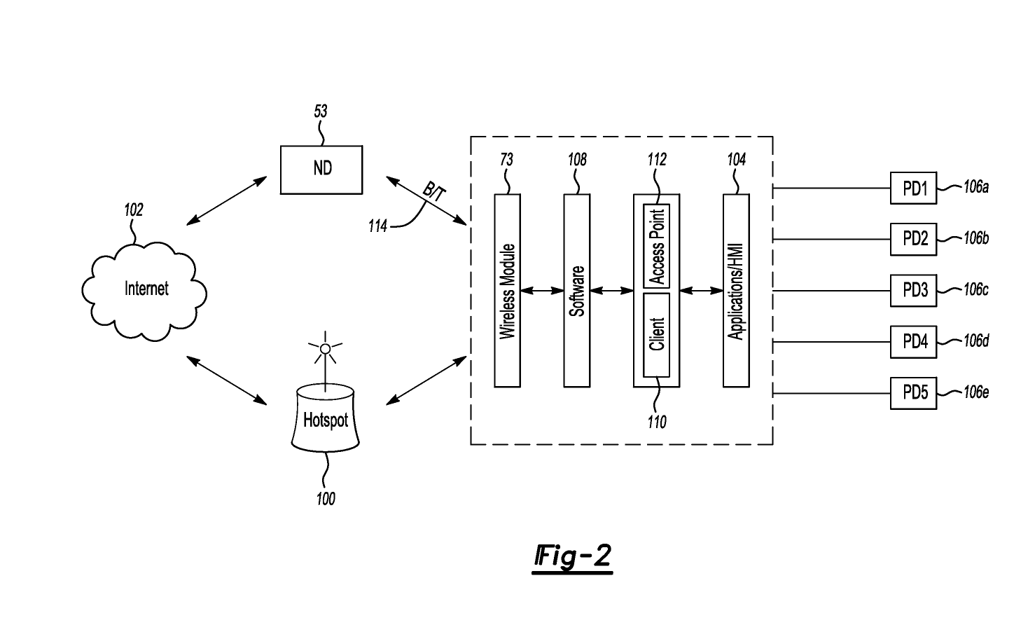

As will be described in further detail below, the VCS 1 may serve multiple WiFi functions and, therefore, operate in multiple WiFi modes. In one embodiment, the VCS 1 may be a WiFi client and, therefore, search for and obtain a connection to a WiFi hotspot 100 (FIG. 2) located outside of the vehicle. Examples of such hotspots may include those offered at retail establishments such as STARBUCKS and MCDONALDS. In other embodiments, the VCS 1 may provide a wireless access point such that, for example, an in-vehicle WiFi hotspot may be established. In additional embodiments, the VCS 1 may be both a client and an in-vehicle wireless access point (sometimes referred to herein as “WAP”). The WAP may be configured to communicate using various wireless standards. Further details of the various modes/functions of the VCS 1 will be described below.

FIG. 2 illustrates an example architecture for WiFi connectivity in a vehicle. As shown in FIG. 1 and FIG. 2, the VCS 1 may be implemented with a wireless communication module receiver/transceiver 73 (e.g., and without limitation, a BLUETOOTH and/or WiFi module). In some embodiments, module 73 may include a WiFi 71 antenna. This may allow the VCS 1 to connect to remote networks in range of the module 73. In this case, the VCS 1 may be a WiFi client. Additionally or alternatively, the wireless module 73 may enable connectivity between VCS 1 and personal devices 106a-e. In this case, the VCS 1 may be a wireless access point and generate an in-vehicle hotspot for personal devices 106a-e.

Personal devices 106a-e may include, but are not limited to, personal computer (such as laptops), nomadic devices (including, but not limited to, PDAs and smartphones), personal media players, and the like. These devices are used by vehicle occupants to generate a connection to the Internet 102 via the VCS 1 (i.e., the wireless access point which serves as a gateway) and a nomadic device (e.g., ND 53). The VCS 1 may serve as an Internet gateway when the VCS 1 is in an access point mode.

An internet enabled ND 53 may tether to the VCS 1 via a wireless connection 114 (e.g., BLUETOOTH). Accordingly, using the ND 53, the VCS 1 may serve as a gateway to Internet connectivity for personal devices 106a-e connected in the vehicle via the VCS 1.

Additionally, or alternatively, when the VCS 1 is in access point mode, the VCS 1 may also serve as a gateway to provision a local area network (LAN) within the vehicle. In this case, the tethering of the ND 53 may or may not be required. Further details of the access point mode will be described below.

The module 73 may communicate with software 108 installed to the VCS 1 to process and exchange wireless commands and function calls. In some embodiments, the software may be implemented as a dynamic link library (DLL).

The VCS 1 may also have a network interface for each WiFi mode enabled by the VCS 1. For example, there may be a client network interface 110 for the client mode and/or an access point (AP) network interface 112 for the AP mode. The HMI 104 of the VCS 1 may communicate with each interface using device-specific system calls.

The VCS 1 may activate an interface based on instructions to enter a particular mode. The instructions may be given by a user, for example, through tactile or voice commands in the vehicle. As an example, and without limitation, a vehicle occupant may use the display 4 to select the client mode or the AP mode. As another example, the user may speak a command to enter a mode such as (without limitation) “find hotspot” which may cause the VCS 1 to enter client mode. It should be understood that this example is for illustration purposes only. In some embodiments, the mode which may be used may be based on vehicle travel. For example, the VCS 1 client mode interface 110 may not be enabled when the vehicle is travelling to avoid driver distraction. Therefore, when the vehicle is stationary and/or in park, the client mode may be activated. It will be appreciated, however, that if the VCS 1 is in client mode and the vehicle is in motion while still in client mode, the WiFi connection to the hotspot 100 may not be dropped until the vehicle is out of range of the hotspot 100. To re-connect, the vehicle will have to be stationary and/or in park.

Further details of the client mode and the AP mode of the VCS 1 will now be described. As described above, in one embodiment, the VCS 1 may be connected to the Internet (or other wireless network) using an external hotspot 100. For example, this hotspot may be a WiFi hotspot. Without limiting the foregoing, the hotspot 100 will be referred to herein as a WiFi hotspot. The VCS 1 may generally connect to the WiFi hotspot when the vehicle is stationary (such as in a parking lot), however, this is not required. The VCS 1 may connect to hotspots 100, if possible, during vehicle travel as well. When the VCS 1 connects to a hotspot 100, the VCS 1 may be operating in a client mode, thereby receiving and transmitting data over the Internet 102 via the hotspot 100. As a client, the VCS 1 may be used by a vehicle occupant (e.g., a driver or passenger) to perform the following non-limiting, non-exhaustive events/activities: browse content (including, but not limited to, web browsing, RSS feeds, podcasts, electronic mail, social networking, and the like), install telematics updates and perform telematics messaging (including, but not limited to, diagnostics such vehicle health reports), and content/data synchronization. In some embodiments, data synchronization may occur at vehicle startup or at predetermined times (which may be user defined or preset in the VCS 1).

The user may use the VCS HMI 104 to configure and generate a connection to the hotspot 100. For example, the display 4, which, in some embodiments, may be a touchscreen display, may be utilized to configure the hotspot 100. For example, the display(s) may include an alphabetic or QWERTY keyboard. In some embodiments, the HMI may be comprised of multiple (e.g., at least two) displays. For example, and without limitation, the vehicle computing system 1 may include a display in the center stack and one or more displays in the instrument cluster. These displays may share an identical hardware interface and may comprise of different clock speeds. All, or at least one, of these displays may be touch screen.

In some embodiments, the hotspot configuration/connection may be accomplished via a wizard displayed on the VCS 1. The display 4 may present to the user the available hotspots with which to generate a connection. The user may select the hotspot 100 via a tactile input and/or a voice input. In some embodiments, the VCS 1 may use the GPS data of the hotspot 100 in order to filter and narrow down multiple hotspots that may be available for connection. In additional or alternative embodiments, the VCS 1 may use a cached MAC address of the access point 100.

The VCS 1 may also operate in an access point (AP) mode. In this mode, the VCS 1 may serve as an access point for other devices in the vehicle (e.g. PSP, laptop, nomadic device, rear entertainment systems, etc.) for connection to the vehicle computing system. In this way, an in-vehicle LAN is set up. Additionally or alternatively, the VCS 1 may be utilized as a gateway for other devices within the vehicle to the internet using an alternate Internet connection mechanism, such as ND 53 (as described above). This is especially compelling when the vehicle is in motion and hotspot 100 may not be available. Using this mode, a vehicle occupant may perform the following non-limiting, non-exhaustive activities: Filing sharing via the VCS 1, in vehicle media streaming, and Internet browsing (via, e.g., the ND 53).

The user may also select this mode via the HMI of the VCS 1 as described above with respect to the client mode. When the VCS 1 switches to this mode, command may be sent via the VCS HMI 104 to the AP network interface 112.

When operating in the AP mode, the VCS 1 may or may not broadcast the AP name. The AP name may be based on a profile name, user name (e.g., the name of the vehicle owner), or a general identification (such as a vehicle ESN). WPA, WPA2, WEP or other information security protocols known to those of skill in the art may be implemented. A default mode, such as WPA2, may be implemented. In-vehicle users may be required to enter a WPA/WPA2/WEP password for access to the AP. The use of WPA/WEP passwords is a well known concept in the art.

The AP mode may also be configured. For example, in some embodiments, the VCS 1 may present the user on devices 106a-e with a notification prompting whether an attempt to connect from the device should be allowed, denied, always allowed, or always denied. This notification may be presented, for example, at a first time connection. However, in some embodiments, the vehicle occupant may be presented with the notification with every connection. When a connection is accepted/denied, the accepted/restricted devices may be stored in database in the VCS 1 (not shown).

In some embodiments, the display 4 may show a vehicle occupant which devices are attempting to connect. A vehicle occupant may individually or together accept/deny the connections. Connections may be accepted and/or denied using tactile and/or verbal inputs. Further, a vehicle occupant may manage stored connections, for example, by clearing and/or modifying stored connection wholly or partially (e.g., individually). Management of connections may be performed from the VCS 1 display 4 and/or through verbal commands. Connection management may be restricted to particular vehicle occupants. For example, vehicle occupants who may be given management access may be given a password (e.g., from the vehicle occupant) to access management controls. As another example, management access may be given to a particular set of individuals who may have individual password (or other identification criteria) for management access. The identification criteria may be set and stored on the VCS 1 or on a portal such as www.syncmyride.com. In this latter embodiment, the VCS 1 may communicate with the portal according to known methods to obtain information authorizing connection management. In some embodiments, a user may also access the portal from a personal computer (not shown) to manage and monitor connections.

The VCS 1 may implement security measures in order to avoid threats and damage to the VCS 1 when operating in either mode. Security measures may include, but are not limited to, incorporating WPA/WEP keys and firewalls.

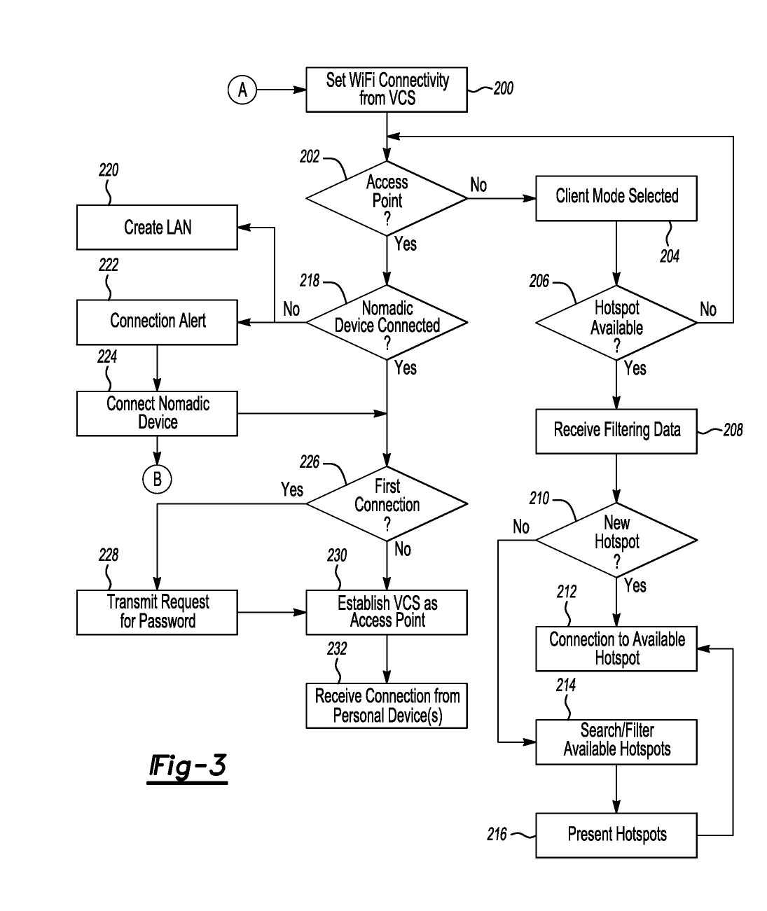

FIG. 3 illustrates a process for generating connectivity in the vehicle. The WiFi connectivity may be activated as illustrated in block 200. Set up may be accomplished through a set up wizard to select a mode for WiFi connectivity. The wizard may also be used to remove connections and prioritize connections.

As described above, the VCS 1 may operate in client mode and an AP mode. The VCS 1 may determine in which mode it is operating (block 202). If it is not in AP mode, then the vehicle occupant may have selected the client mode (block 204).

The VCS 1 may search for a hotspot 100 when in client mode (block 206). A hotspot 100 may or may not be found depending on whether the vehicle is in motion and/or if a hotspot is detectable. If a hotspot 100 is not found, the vehicle occupant may be alerted that the hotspot was not found. The alert may be audible or textual. The audible alert may be a beep, chime, or a spoken alert. VCS 1 may operate in both client and AP mode simultaneously. A failure to connect with the client interface may not impact the AP interface because it may be controlled independently. In some embodiments, if a hotspot connection cannot be made, the VCS 1 may automatically switch to AP mode. Alternatively, a vehicle occupant may manually enter the AP mode.

If the hotspot 100 is found (block 206), the VCS 1 may receive filtering information to determine if the hotspot 100 is a new hotspot (e.g., the hotspot has been previously visited) (block 208). Filtering information may include, but is not limited to, GPS information of the hotspot 100 and/or of the vehicle 31 or a MAC address of the hotspot 100. In some embodiments, the filtering information may be stored on the VCS 1 and a comparison or lookup may occur of the stored information with respect to the received filtering information.

If the hotspot 100 has been previously visited (block 210), the vehicle occupant may be presented with the previously visited available hotspots 100. The vehicle occupant may be connected to a desired hotspot 100 (block 212). In some embodiments, multiple hotspots 100 may be displayed and the user may select the hotspot 100 desired. This may occur, for example, in urban areas where there is a dense population of available hotspots. The configured hotspots may, in some embodiments, be presented according to a priority of hotspots. This priority may be user defined.

If the hotspot 100 had not been previously visited (block 210), the user may be presented (block 216) with the available hotpots after a search of available hotpots 100 (block 214). The user may select a hotspot 100 with which to generate a connection (block 212), upon which, the hotspot 100 may be stored in the VCS 1.

In one embodiment, the user may configure the hotspot connection upon selection of a hotspot. This may include, but is not limited to, setting hotspot priorities, data synchronization, network updates, and the like. In other embodiments, hotpot configuration may occur through a wizard and apply to all selected/stored hotspots 100. As explained above, VCS 1 may operate in client and AP modes simultaneously. When the VCS 1 is not in client mode, the VCS 1 may be in AP mode. AP mode may be used when the vehicle is in motion or when an in-vehicle network is desired. As described above, in this mode, the VCS 1 may be used to create an in-vehicle LAN and/or be used as a gateway for Internet access. In order to obtain access to the Internet, a connection to an additional device may be needed. This device may be nomadic device 53. It should be understood that, additionally or alternatively, this device may be a USB hub (not shown) capable of generating an Internet connection. However, this is an additional device to be carried by the vehicle occupant and, in most cases, requires an additional data plan. Therefore, this is not an optimal solution for obtaining Internet access.

Accordingly, a determination may be made if the ND 53 is connected (i.e., tethered) to the VCS 1 (block 218). If not, it may be that an in-vehicle LAN may be generated (block 220). However, the in-vehicle LAN may not enable Internet access without the tethering of a ND 53. Accordingly, a connection alert may be presented to the vehicle occupant(s) (block 222) if an Internet access is desired. A user may then tether the ND 53 to the VCS 1 via the BLUETOOTH connection (block 224). In some embodiments, a vehicle occupant may also use a physical connection (such as, and without limitation, a USB connection).

An Internet connection may be available upon tethering the ND 53 to the VCS 1. It should be understood that the in-vehicle LAN may be persistent even when the ND 53 is tethered to the VCS 1. Therefore, a vehicle occupant may create an in-vehicle LAN and have access to the Internet.

If the connection is made for the first time (block 226), the VCS 1 may transmit a request for a security (e.g., WPA/WPA2 or WEP) password as is known in the art (block 228). In some embodiments, however, the password request may be transmitted from the VCS 1 for each connection. The password may be a default password set by the OEM. However, the password may be configured by the vehicle owner or a user authorized by the vehicle owner (as described above). Configuration of the password may be accomplished from the VCS 1 and/or a personal computer using a web portal (as described above).

Authorization to an AP using the WPA/WPA2/WEP key is known in the art. When access to the AP is authorized, the VCS 1 may be established as an AP (block 230). As described above, the VCS 1 may have an SSID associated with it. This SSID may be a default name or configured by the user.

When the AP connection has been established, the personal devices 106a-e may submit a connection request to connect to the AP so that an Internet connection can be established with the ND 53 (block 232). Once a personal device 106a-e is connected to the AP, data can be exchanged via the Internet enabled ND 53. Thus, the VCS 1 routes information between the ND 53 and the personal device 106a-e during an Internet connection thereby serving as an Internet gateway.

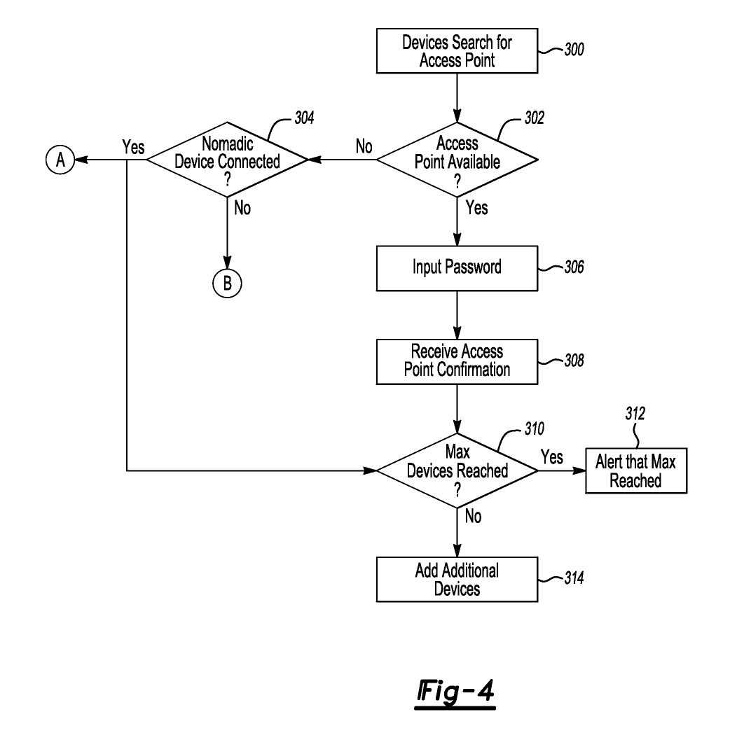

FIG. 4 illustrates a process performed by the personal device 106a-e for detecting an accessing point. As illustrated in block 300, the devices search for an access point with which to connect. If one is not available (block 302), it may be determined if a nomadic device is connected (block 304). In some embodiments, the vehicle occupant may be presented with an alert that the nomadic device is not connected (block 202, FIG. 3). If the vehicle occupant finds that the nomadic device is connected, the WiFi set up process may be performed as illustrated by circle block A. In this case, it may be that the VCS 1 is not in access point mode. If the ND 53 is not connected, the nomadic device may be connected/tethered as illustrated by circle block B.

When the AP is available (block 302), a vehicle occupant may enter the security password (block 306) to establish the connection. Once connected, a confirmation may be received that the connection has been established (block 308).

In some embodiments, a maximum amount of devices may be permitted to establish a connection (block 310). Accordingly, referring back to block 304, if the ND 53 is connected, a determination may be made if the maximum amount of devices has been reached. If so, an alert may be presented to the user that the maximum amount has been reached (block 312). If not, then additional devices may be added (block 314).

Another embodiment of the present invention includes VCS 1 (FIG. 1) monitoring GPS 24 and vehicle gear position (e.g. PRDNL) to determine a geographic location at which the vehicle is parked. Gear position may be provided to VCS 1 over a vehicle data communications bus (not shown). Vehicle 31 may determine whether the vehicle is in the vicinity of a known hotspot by querying a database (e.g. HDD 7) or by communication with a remote server at network 61. Database 7 or server at network 61 may include a look-up table of known or otherwise predefined public or private hotspots organized by geographic location or region.

While exemplary embodiments are illustrated and described above, it is not intended that these embodiments illustrate and describe all possibilities. Rather, the words used in the specification are words of description rather than limitation, and it is understood that various changes may be made without departing from the spirit and scope of the invention.

What is claimed:

1. A vehicle computer system comprising:
a processor in communication with a human machine interface for control by a user and one or more wireless transceivers for wireless data communication, the processor being capable of being paired to a nomadic computing device having wireless Internet connectivity, and being configured to:
wirelessly connect to one or more personal computing devices in the vicinity of the vehicle; and
provide a wireless Internet access point to the one or more personal computing devices based on the wireless connection and the Internet connectivity.

2. The system of claim 1 wherein the vehicle computer is further configured to receive an input from the HMI for connecting to the one or more personal computing devices.

3. The system of claim 1 wherein the processor of the vehicle computer system is further configured to:
receive vehicle transmission position information indicating whether the vehicle is in park;
receive geographic coordinates from a GPS device;
query a database to identify one or more known hotspots in the vicinity of the vehicle; and
attempt to connect to one or more of the known hotspots.

4. The system of claim 2 wherein the vehicle computer is further configured to:
in response to the input, receive an instruction at an access point interface on the vehicle computer; and
trigger activation of the access point interface for providing the wireless Internet access point.

5. The system of claim 1 wherein the vehicle computer system is further configured to provide Internet connectivity to a vehicle rear entertainment system.

6. The system of claim 1 wherein the vehicle computing system is configured to support client network and access point modes simultaneously.

7. The system of claim 1 wherein the vehicle computer is tethered to the nomadic device via BLUETOOTH connection.

8. A method for in-vehicle wireless connectivity comprising:
receiving input defining two or more modes for wireless connectivity of a vehicle computer, the two or more modes comprising a client mode for connecting to a connection point outside of a vehicle and an in-vehicle access point mode for generating an in-vehicle connection point;
if the vehicle computer is in client mode,
searching for a connection to one or more connection points outside of the vehicle; and
establishing the connection when the connection is found; and
if the vehicle computer is in in-vehicle access point mode,
tethering a nomadic device configured to establish an Internet connection to the vehicle computer; and
providing a wireless Internet access point for one or more personal computing devices based on the wireless connection and the Internet connection.

9. The method of claim 8 wherein the vehicle computer comprises a vehicle human machine interface (HMI) for control by a user.

10. The method of claim 8 wherein the vehicle computer is in client mode and access point mode simultaneously.

11. The method of claim 8 additionally comprising providing Internet connectivity to a vehicle rear entertainment system.

12. The method of claim 8 additionally comprising establishing a wireless connection to one or more computing devices in the vicinity of the vehicle.

13. The method of claim 8 wherein establishing the connection includes:
receiving filtering data for determining if the one or more connection points has been visited;
filtering the connection points based on the filtering data; and
presenting the connection point(s) based on the filtering.

14. The method of claim 13 wherein the filtering data includes GPS data.

15. The method of claim 8 wherein tethering the nomadic device to the vehicle computer includes establishing a BLUETOOTH connection.

16. The method of claim 15 wherein the nomadic device is a cellular telephone.

17. The method of claim 8 wherein the personal computing devices include mobile phone and personal computers.

18. A method comprising:
receiving a connection request on a vehicle computer to establish in-vehicle wireless connectivity;
in response, determining if a nomadic device configured to establish an Internet connection is tethered to the vehicle computer;
if not tethered, transmitting a tethering notification;
if tethered, wirelessly connecting to computing devices in the vehicle's vicinity; and
providing an access point to the computing devices based on the wireless and Internet connections.
